(19) United States
(12) Patent Application Publication
(10) Pub. No.: US 2008/0245297 A1
(43) Pub. Date: Oct. 9, 2008

(54) Material supply apparatus

(75) Inventors: Ken Nakahara, Kyoto (JP); Hiroyuki Yuji, Kyoto (JP); Kentaro Tamura, Kyoto (JP); Shunsuke Akasaka, Kyoto (JP); Masashi Kawasaki, Miyagi (JP); Akira Ohtomo, Miyagi (JP); Atsushi Tsukazaki, Miyagi (JP)

Correspondence Address: RABIN & Berdo, PC, 1101 14TH STREET, NW, SUITE 500, WASHINGTON, DC, 20005, US

(73) Assignee: ROHM CO., LTD., Kyoto-fu (JP)

(21) Appl. No.: 12/078,322

(22) Filed: Mar. 28, 2008

(30) Foreign Application Priority Data
Mar. 30, 2007 (JP) 2007-091388

(51) Int. Cl. B05C 5/00

(52) U.S. Cl. 118/300

(57) ABSTRACT

A container of a material supply apparatus is configured of a crucible and an orifice. The crucible has a cylindrical shape, a rectangular-column shape or the like, and is hollow. Heat sources such as heaters are disposed around the crucible. The orifice including an opening is provided on a side of the crucible in a material element supplying direction. The orifice includes a pipe portion that extends in the material element supplying direction. The opening is formed on a tip of the pipe portion. An opening area of the pipe portion is formed to become gradually narrower towards the material element supplying side, namely in a direction of the opening.

### CROSS REFERENCE TO RELATED APPLICATIONS AND INCORPORATION BY REFERENCE

This application is based upon and claims the benefit of prior Japanese Patent Application P2007-91388 filed on Mar. 30, 2007; the entire contents of which are incorporated by reference herein.

### BACKGROUND OF THE INVENTION

1. Field of the Invention

The present invention relates to a material supply apparatus used in a thin film forming apparatus that forms a predetermined thin film and the like on a substrate.

2. Description of the Related Art

Electronics is a field in which semiconductor materials, such as silicon, play an active role. In recent years, the physical properties of silicon materials have been impeding the development of device configurations that can satisfactorily implement functions actually required. For example, the physical properties of silicon do not allow a device made of silicon to operate under high temperatures of 150° C. or more, and even have a risk that the silicon itself will burst into flames.

Meanwhile, oxides and organic substances are receiving attention as materials for the next generation because of their large number of species and diverse functions. The oxides and organic materials include a high-temperature superconductor YBCO, an ultraviolet emission material ZnO, an organic electroluminescent (EL) material and the like. These materials may actualize functions that could not be achieved because of the limits of the physical properties of silicon.

For example, ZnO draws attention owing to the multifunctionality and light emission potential. From the perspective of purification, ZnO is often produced by use of plasma assisted molecular beam epitaxy (MBE) in which Zn is supplied as Zn elements generated a metal Zn by sublimation while oxygen is supplied as oxygen radicals generated from the oxygen by plasma cracking. However, because the oxygen is actively supplied in a high chemical activation state, the Zn material is easily oxidized. This makes it difficult to stabilize Zn material supply.

To supply Zn elements to a growth chamber within an MBE apparatus, a bubbling method such as metal-organic chemical vapor deposition (MOCVD) is not used. Instead of this, used is one type of material supply apparatus typified by a molecular beam cell referred to as a Knudsen cell or a K cell, for example. This type of material supply apparatus supplies material element through sublimation of a raw material as described in Japanese Patent Application Publications Nos. 2005-276952 and Hei 7-14765.

When the elements of a material, such as Zn, having a high vapor pressure and a regular usage temperature of 400° C. or less is supplied, the temperature of the cell is required to be stably maintained at a low temperature. However, a low temperature is difficult to control because the temperature fluctuates with a slight change in environment. For this reason, stable supply of a desired material is difficult, so that a yield rate and the like deteriorate. Therefore, when the material element is supplied through sublimation, it is demanded that the temperature be raised as high as possible.

When an oxide, such as ZnO, is generated, very highly chemically active oxygen is simultaneously used with the elements supplied from the material supply apparatus. In this case, oxygen enters a crucible that is a component of the material supply apparatus, and oxidizes a raw material in the crucible. This produces a problem of unstable supply or supply failure of the material supply.

All the problems described above can be solved if the material supply apparatus employs a configuration in which the area of an opening for discharging the material elements is narrowed while the internal pressure is increased. Possible means for narrowing the opening area is to provide the opening with an orifice that narrows the opening area without changing the shape of the crucible. This means is effective from the viewpoint that optimization modification is easy to carry out, limits to shapes of inserted material are minimal, and the like.

Growth of ZnO using the plasma-assisted MBE will be described as an example. As shown in FIG. 9, in the material supply apparatus, a raw material (Zn) 14 is placed in a cylindrical crucible 11. The interior of the crucible 11 is heated by a heat source 12. To form a ZnO crystal thin film, Zn with a vapor pressure of about 10⁻⁶ Torr is required to be supplied. However, if a crucible 11 is an ordinal cylindrical one, oxygen radicals will enter the crucible 11 from a large opening, easily oxidizing the raw material 14 within the crucible 11. FIG. 8A shows oxidized Zn and un-oxidized Zn of the Zn that is the raw material 14 in the crucible 11. When an upper portion of the raw material 14 is oxidized in this way, Zn vapors cannot be generated and become unstable because of obstruction by the oxide film. In addition, the crucible 11 holding the Zn is usually heated within a range of 260° to 280° C. However, this temperature control is difficult because the temperature range is low.

To solve these problems, an orifice 13 having a narrow opening 13a is inserted in the crucible 11 as shown in the FIG. 9 to narrow the opening area of the crucible 11 in a mid portion thereof. In this case, the internal pressure in the crucible 11 is increased, so that the crucible 11 can be heated at a temperature higher than a conventional crucible and that oxidization of the raw material 14 can be suppressed. However, as shown in FIG. 8B, Zn grows on the orifice 13 and the opening 13a becomes clogged. When an orifice that narrows the opening area is attached in this way, the temperature of the crucible can be increased and oxidization of the raw material can be prevented. However, a new problem arises and impedes stable supply of the material elements.

### SUMMARY OF THE INVENTION

The present invention has been achieved to solve the above-described problems. An object of the invention is to provide a material supply apparatus capable of increasing a supply temperature for material elements to stably supply the material elements.

The invention according to claim 1 is a material supply apparatus that supplies a material element by sublimating a raw material within a container. The container includes a pipe portion formed to have an opening area that becomes narrower and narrower from a predetermined position towards an opening for discharging the material elements. The pipe portion extends towards a material element supplying side.

The invention according to claim 2 is the material supply apparatus according to claim 1, in which a material formed through the supply of the material element is an oxide.

In the material supply apparatus of the present invention, the container in which a raw material is disposed has the pipe portion formed to have the opening area that becomes narrower and narrower from the predetermined position towards the opening for discharging the material element and to extend towards the material element supplying side. As compared to an apparatus configured to have an opening that is formed to be narrow in a mid portion of the container, the material supply apparatus of the present invention prevents the sublimated material elements from covering and blocking the opening when the raw material is sublimated within the container.

### BRIEF DESCRIPTION OF THE DRAWINGS

FIG. 1 is a diagram of a configuration of a material supply apparatus of the present invention;

FIG. 2 is a diagram of a configuration of an orifice;

FIG. 3 is a diagram of a modified example of the configuration of the orifice;

FIG. 4 is a diagram of a comparison of relationships between a cell temperature and a beam flux in the respective cases where the orifice is attached outwardly and inwardly;

FIGS. 5A and 5B are cross-sectional views of the configuration in FIG. 1 shown in a more schematic manner;

FIGS. 6A and 6B are cross-sectional views of a configuration in FIG. 9 shown in a more schematic manner;

FIG. 7 is a diagram of an orifice opening after material elements are supplied by using the configuration in FIG. 1;

FIG. 8A is a diagram of an interior of a crucible after material elements are supplied by using the configuration in FIG. 9;

FIG. 8B is a diagram of an orifice opening when material elements are supplied by using the configuration in FIG. 9; and

FIG. 9 is a diagram of a configuration of a material supply apparatus to which the orifice is inwardly attached.

### DETAILED DESCRIPTION OF THE PREFERRED EMBODIMENTS

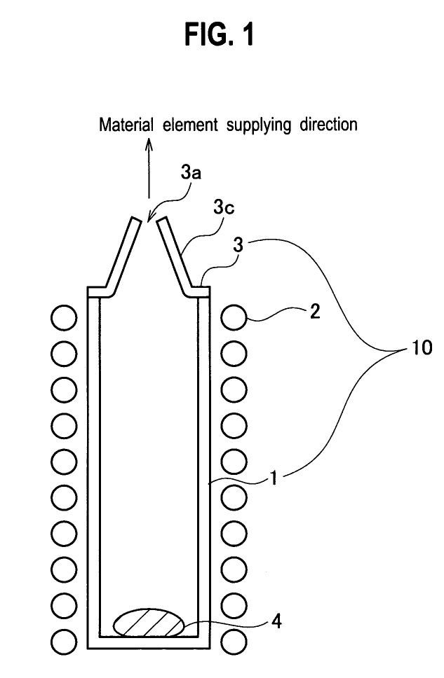

An embodiment of the present invention will be described with reference to the drawings. FIG. 1 is a diagram of a configuration of a material supply apparatus of the present invention.

A container 10 of the material supply apparatus is configured of a crucible 1 and an orifice 3. In FIG. 1, the crucible 1 and the orifice 3 are separated. However, a container 10 in which the crucible 1 and the orifice 3 are integrally formed can also be used. The crucible 1 has a cylindrical shape, a rectangular-column shape or the like, and is hollow. The crucible 1 is formed of pyrolitic boron nitride (PBN), silica and the like. Heat sources 2 such as heaters are disposed around the crucible 1. The orifice 3 having an opening 3a is provided to a side of the crucible 1 in a material element supplying direction.

The side in the material element supplying direction in the diagram indicates a side closer to a growth chamber in a thin film forming apparatus (such as a MBE apparatus) in which the material supply apparatus is used. More specifically, the side in the material element supplying direction faces toward a substrate for semiconductor thin film growth disposed within the growth chamber.

As shown in FIG. 1, the orifice 3 includes a pipe portion 3c that extends towards the material element supplying side. The opening 3a is formed on a tip of the pipe portion 3c. An opening area of the pipe portion 3c is formed so as to become gradually narrower towards the material element supplying side, namely in a direction of the opening 3a.

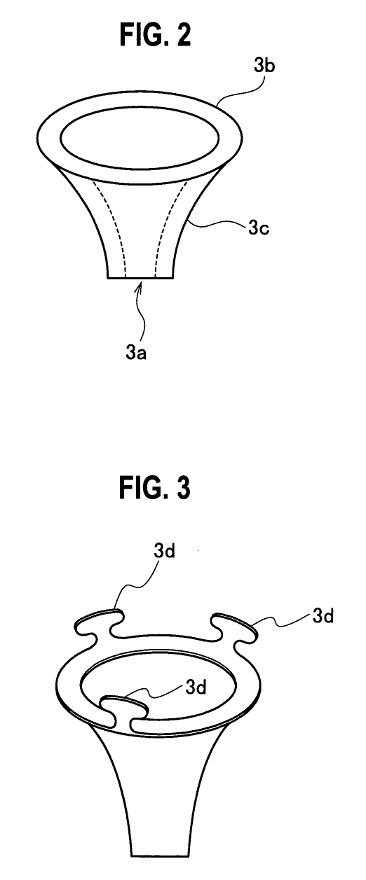

FIG. 2 shows the orifice 3 in more detail. The orifice 3 includes a rim 3b provided in an upper portion of the orifice 3 and the pipe portion 3c connected to the rim 3b. The opening 3a is formed in the pipe portion 3c. The pipe portion 3c is formed in a shape with a hole to allow particles to pass. When the orifice 3 shaped as shown in FIG. 2 is turned upside down and attached to the crucible 1, the orifice 3 appears as shown in FIG. 1.

A raw material 4 is inserted into the crucible 1 and is sublimated by heat from the heat sources 2. The sublimated material elements advance towards the exit in the crucible 1 and are discharged from the opening 3a towards the substrate for growth disposed in the growth chamber of the thin film forming apparatus.

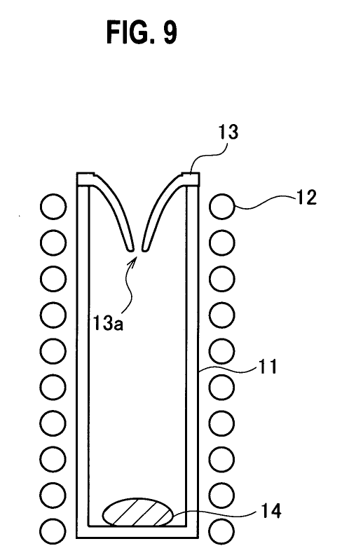

Compared with FIG. 9, the configuration of the present invention in FIG. 1 is the substantially same as in the case where the orifice in FIG. 9 is outwardly attached. Effects achieved when the configuration of the present invention is used will be described below in comparison with the case where the orifice is inwardly attached such as shown in FIG. 9.

First, we examined a relationship between a crucible temperature (cell temperature) and a beam flux discharged from the inside of the crucible for both cases where the orifice is outwardly attached as shown in FIG. 1 and is inwardly attached as shown in FIG. 9. As an example, an MgZnO thin film was formed by plasma-assisted MBE. Then, we compared relationships between an Mg cell (crucible) temperature and an Mg flux after these relationships were respectively obtained by using the material supply apparatuses in FIGS. 1 and 9 as an apparatus supplying the Mg elements. A crystal oscillator was used to measure the flux. Like Zn, Mg has a high vapor pressure and a regular cell temperature for Mg is set to about 350° C. Once Mg is oxidized to form MgO in its surface, Mg elements are not supplied any longer. In this regard, Zn is little bit more preferable because at least the material supply of Zn is not completely stopped even in such a case. Mg is one of the most difficult materials in terms of controlling material supply.

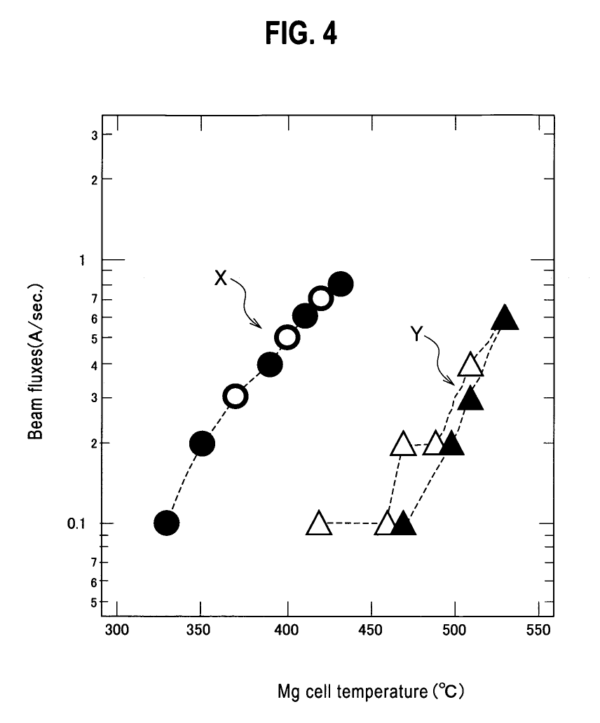

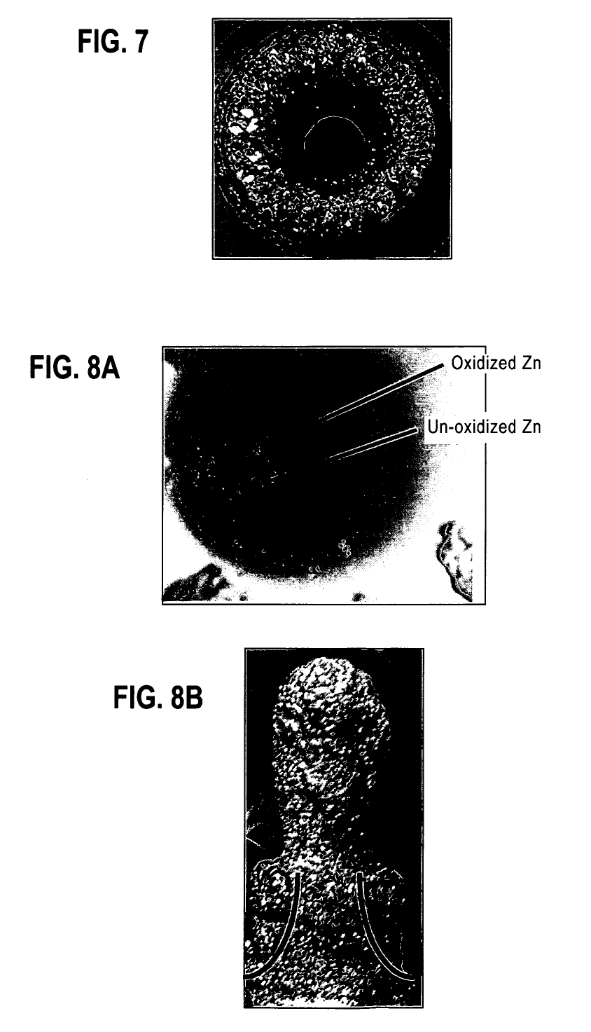

The Result of the above-described comparison is shown in FIG. 4. X indicates the relationship between the Mg cell temperature and the beam flux in the configuration in FIG. 1. Y indicates the relationship between Mg cell temperature and the beam flux in the configuration in FIG. 9. An open circle (◯) in the X graph indicates an increase in cell temperature, while a solid circle () indicates a decrease in cell temperature. In addition, an open triangle ( [symbol] ) in the Y graph indicates an increase in cell temperature, while a solid triangle (▴) indicates a decrease in cell temperature. As can be seen from this graph, the flux is more stable against temperature change in the outward orifice structure (configuration in FIG. 1) than otherwise. Moreover, a temperature required to obtain a desired flux is low because the opening of the orifice for discharging the material elements is not blocked. When the configuration in FIG. 1 is used, Zn is deposited on the circumference of the orifice 3 as shown in FIG. 7, but does not block the opening 3a. Thus, the opening 3a remains open.

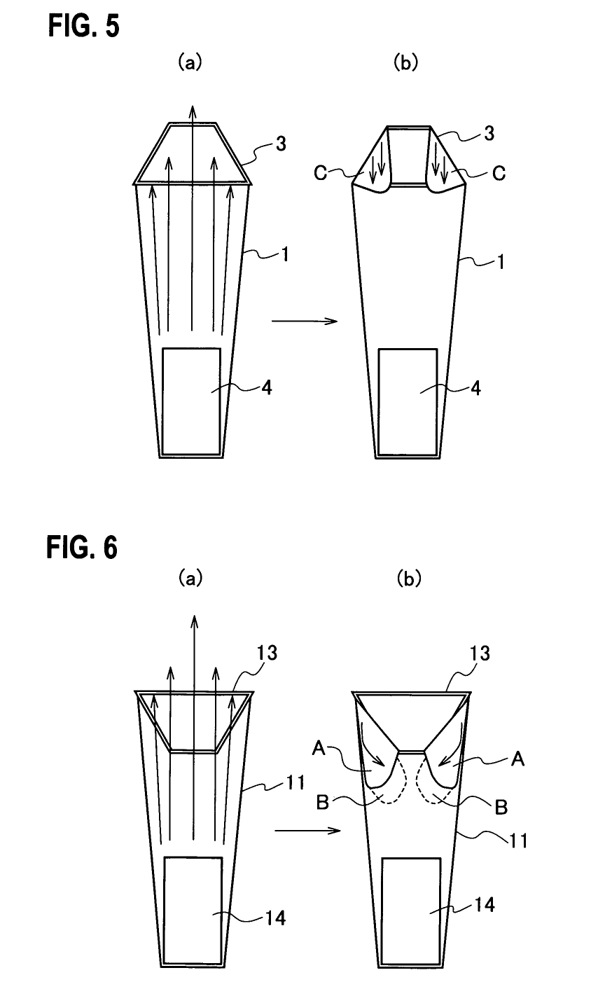

Although the reason whey the opening 3a is not blocked is not very clear, the following reasons can be considered. FIGS. 5A and 5B are cross-sectional views of the configuration in FIG. 1 in a more schematic manner by using the same reference numbers as in FIG. 1. FIGS. 6A and 6B are cross-sectional views of the configuration in FIG. 9 in a more schematic manner by using the same reference numbers as in FIG. 9. In FIG. 1 and FIG. 9, the crucibles are each drawn with a shape having the same opening area at an upper portion and lower portion thereof. However, actually, as shown in FIGS. 5A, 5B, 6A and 6B, the upper portion of the crucible is wider than the lower portion. The crucible is formed to facilitate the discharge of molecular beams.

Here, when the orifice is inwardly disposed, a narrow space A is formed between the crucible 11 and the orifice 13 as shown in FIG. 6B. The space A is so narrow that the space A is rapidly filled after material elements generated by sublimation of the raw material 14 start to be deposited onto the orifice 13. When the space A is filled, the crucible 11 is in the same status as in a short (length) crucible having a small hole. As a result, the substantial length of the crucible is shortened, which accordingly shortens a distance from the raw material 14 to the deposits in the area A as shown in FIG. 6B. Therefore, the deposits in the area A grow and expand inwardly (in a direction of the arrows in FIG. 6B). Then, the deposits grow to occupy an area B indicated by the dotted lines in FIG. 6B, and eventually, the opening 13a of the orifice 13 becomes blocked.

In contrast, when the orifice is outwardly disposed as shown in FIG. 5, no peculiar narrow space as indicated by the area A in FIG. 6B appears. Therefore, even when the material elements generated by the sublimation of the raw material 4 start to be deposited onto the circumference of the opening 3a of the orifice 3 and expand to occupy an area C in FIG. 5B, the deposits grow in the direction indicated by the arrow in FIG. 5B rather than inward. Therefore, a certain fixed area can be secured for the opening of the orifice 3. This opening area avoids an occurrence of the phenomenon described in FIG. 6B. Thus, an effective length of the crucible does not easily change, which prevents the deposits from easily blocking the opening 3a.

As described above, the pipe portion is provided on the container holding the raw material in the material supply apparatus. More specifically, the pipe portion is formed to have the opening area that becomes narrower and narrower from a predetermined position towards the opening for discharging the material elements and to extend in the material element supplying direction. With this configuration, when the raw material is sublimated within the container, the sublimated material elements are not deposited to an extent that the opening is blocked. This allows the material elements to be supplied stably.

FIG. 3 shows a modified example of the configuration of the orifice 3. In the configuration in FIG. 3, projections 3d are additionally formed in three locations of the configuration in FIG. 2. The material supply apparatus is so hot after use that a machine is used to exchange the orifice or to cause the orifice to face inward or outward by turning the orifice upside down. The projections 3d allow the orifice to be hung by a wire and the like and thereby to be moved easily. When the configuration of the present invention is used, the orifice in FIG. 3 is turned upside down and attached to the crucible 1.

In this way, it is obvious that the present invention includes various embodiments and the like other than those described herein. Therefore, the technical scope of the present invention is prescribed only by the claims below that are pertinent to the explanation above.

What is claimed is:

1. A material supply apparatus comprising:
a container in which a raw material is sublimated to supply material elements, wherein
the container includes a pipe portion formed to have an opening area that becomes narrower and narrower from a predetermined position towards an opening for discharging the material elements, the pipe portion extending towards a material element supplying side.

2. The material supply apparatus according to claim 1, wherein a material formed through the supply of the material elements is an oxide.
